(19) United States
(12) Patent Application Publication
(10) Pub. No.: US 2011/0286628 A1
(43) Pub. Date: Nov. 24, 2011

(54) SYSTEMS AND METHODS FOR OBJECT RECOGNITION USING A LARGE DATABASE

(76) Inventors: Luis F. Goncalves, Pasadena, CA (US); Jim Ostrowski, Pasadena, CA (US); Robert Boman, Thousand Oaks, CA (US)

(21) Appl. No.: 13/107,824

(22) Filed: May 13, 2011

Related U.S. Application Data
(60) Provisional application No. 61/395,565, filed on May 14, 2010.

(51) Int. Cl. G06K 9/00; G06K 9/68

(52) U.S. Cl. 382/103; 382/218; 382/165

(57) ABSTRACT

A method of organizing a set of recognition models of known objects stored in a database of an object recognition system includes determining a classification model for each known object and grouping the classification models into multiple classification model groups. Each classification model group identifies a portion of the database that contains the recognition models of the known objects having classification models that are members of the classification model group. The method also includes computing a representative classification model for each classification model group. Each representative classification model is derived from the classification models that are members of the classification model group. When a target object is to be recognized, the representative classification models are compared to a classification model of the target object to enable selection of a subset of the recognition models of the known objects for comparison to a recognition model of the target object.

### RELATED APPLICATION

This application claims benefit under 35 U.S.C. §119(e) of U.S. Provisional Application No. 61/395,565, titled “System and Method for Object Recognition with Very Large Databases,” filed May 14, 2010, the entire contents of which is incorporated herein by reference.

### BACKGROUND INFORMATION

The field of this disclosure relates generally to systems and methods of object recognition, and more particularly but not exclusively to managing a database containing a relatively large number of models of known objects.

Visual object recognition systems have become increasingly popular over the past few years, and their usage is expanding. A typical visual object recognition system relies on the use of a plurality of features extracted from an image, where each feature has associated with it a multi-dimensional descriptor vector which is highly discriminative and can enable distinguishing one feature from another. Some descriptors are computed in such a form that regardless of the scale, orientation or illumination of an object in sample images, the same feature of the object has a very similar descriptor vector in all of the sample images. Such features are said to be invariant to changes in scale, orientation, and/or illumination.

Prior to recognizing a target object, a database is built that includes invariant features extracted from a plurality of known objects that one wants to recognize. To recognize the target object, invariant features are extracted from the target object and the most similar invariant feature (called a “nearest-neighbor”) in the database is found for each of the target object's extracted invariant features. Nearest-neighbor search algorithms have been developed over the years, so that search time is logarithmic with respect to the size of the database, and thus the recognition algorithms are of practical value. Once the nearest-neighbors in the database are found, the nearest-neighbors are used to vote for the known objects that they came from. If multiple known objects are identified as candidate matches for the target object, the true known object match for the target object may be identified by determining which candidate match has the highest number of nearest-neighbor votes. One such known method of object recognition is described in U.S. Pat. No. 6,711,293, titled “Method and apparatus for identifying scale invariant features in an image and use of same for locating an object in an image.”

The difficulty with typical methods, however, is that as the database increases in size (i.e., as the number of known objects desired to be recognized increases), it becomes increasingly difficult to find the nearest-neighbors because the algorithms used for nearest-neighbor search are probabilistic. The algorithms do not guarantee that the exact nearest-neighbor is found, but that the nearest-neighbor is found with a high probability. As the database increases in size, that probability decreases, to the point that with a sufficiently large database, the probability approaches zero. Thus, the inventors have recognized a need to efficiently and reliably perform object recognition even when the database contains a large number (e.g., thousands, tens of thousands, hundreds of thousands or millions) of objects.

### SUMMARY OF DISCLOSURE

This disclosure describes improved object recognition systems and associated methods.

One embodiment is directed to a method of organizing a set of recognition models of known objects stored in a database of an object recognition system. For each of the known objects, a classification model is determined. The classification models of the known objects are grouped into multiple classification model groups. Each of the classification model groups identifies a corresponding portion of the database that contains the recognition models of the known objects having classification models that are members of the classification model group. For each classification model group, a representative classification model is computed. Each representative classification model is derived from the classification models of the objects that are members of the classification model group. When an attempt is made to recognize a target object, a classification model of the target object is compared to the representative classification models to enable selection of a subset of the recognition models for comparison to a recognition model of the target object.

Additional aspects and advantages will be apparent from the following detailed description of preferred embodiments, which proceeds with reference to the accompanying drawings.

### BRIEF DESCRIPTION OF THE DRAWINGS

FIG. 1 is a block diagram of an object recognition system according to one embodiment.

FIG. 2 is a block diagram of a database of the system of FIG. 1 containing models of known objects, according to one embodiment.

FIG. 3 is a block diagram of a small database formed in the database of the system of FIG. 1, according to one embodiment.

FIG. 4 is a flowchart of a method, according to one embodiment, to divide the database of FIG. 2 into multiple small databases.

FIG. 5 is a flowchart of a method to generate a classification signature of an object, according to one embodiment.

FIG. 6 is a flowchart of a method to generate the classification signature of an object, according to another embodiment.

FIG. 7 is a flowchart of a method to generate the classification signature of an object, according to another embodiment.

FIG. 8 is a flowchart of a method to compute a reduced dimensionality representation of a vector derived from an image of an object, according to one embodiment.

FIG. 9 is a graph representing a simplified 2-D classification signature space in which classification signatures of known objects are located and grouped into multiple classification signature groups.

FIG. 10 is a flowchart of a method to recognize a target object, according to one embodiment.

FIG. 11 is a flowchart of a method to divide the database of FIG. 2 into multiple small databases or bins, according to one embodiment.

FIG. 12 is a flowchart of a method to recognize a target object using a database that is divided in accordance with the method of FIG. 11.

FIG. 13 is a flowchart of a method to select features to include in a classification database of the system of FIG. 1, according to one embodiment.

### DETAILED DESCRIPTION OF PREFERRED EMBODIMENTS

With reference to the above-listed drawings, this section describes particular embodiments and their detailed construction and operation. The embodiments described herein are set forth by way of illustration only and not limitation. Skilled persons will recognize in light of the teachings herein that there is a range of equivalents to the example embodiments described herein. Most notably, other embodiments are possible, variations can be made to the embodiments described herein, and there may be equivalents to the components, parts, or steps that make up the described embodiments.

For the sake of clarity and conciseness, certain aspects of components or steps of certain embodiments are presented without undue detail where such detail would be apparent to skilled persons in light of the teachings herein and/or where such detail would obfuscate an understanding of more pertinent aspects of the embodiments.

Various terms used herein will be recognized by skilled persons. However, example definitions are provided below for some of these terms.

### Geometric Point Feature, Point Feature, Feature, Feature Point, Keypoint:

A geometric point feature, also referred to as a “point feature,” “feature,” “feature point,” or “keypoint,” is a point on an object that is reliably detected and/or identified in an image representation of the object. Feature points are detected using a feature detector (a.k.a. a feature detector algorithm), which processes an image to detect image locations that satisfy specific properties. For example, a Harris Corner Detector detects locations in an image where edge boundaries intersect. These intersections typically corresponds to locations where there are corners on an object. The term “geometric point feature” emphasizes that the features are defined at specific points in the image, and that the relative geometric relationship of features found in an image is useful for the object recognition process. The feature of an object may include a collection of information about the object such as an identifier to identify the object or object model to which the feature belongs; the x and y position coordinates, scale and orientation of the feature; and a feature descriptor.

### Corresponding Features, Correspondences, Feature Correspondences:

Two features are said to be “corresponding features” (also referred to as “correspondences” or “feature correspondences”) if they represent the same physical point of an object when viewed from two different viewpoints (that is, when imaged in two different images that may differ in scale, orientation, translation, perspective effects and illumination).

### Feature Descriptor, Descriptor, Descriptor Vector, Feature Vector, Local Patch Descriptor:

A feature descriptor, also referred to as “descriptor,” “descriptor vector,” “feature vector,” or “local patch descriptor” is a quantified measure of some qualities of a detected feature used to identify and discriminate one feature from other features. Typically, the feature descriptor may take the form of a high-dimensional vector (feature vector) that is based on the pixel values of a patch of pixels around the feature location. Some feature descriptors are invariant to common image transformations, such as changes in scale, orientation, and illumination, so that the corresponding features of an object observed in multiple images of the object (that is, the same physical point on the object detected in several images of the object where image scale, orientation, and illumination vary) have similar (if not identical) feature descriptors.

### Nearest-neighbor:

Given a set V of detected features, the nearest-neighbor of a particular feature v in the set V, is the feature, w, which has a feature vector most similar to v. This similarity may be computed as the Euclidean distance between the feature vectors of v and w. Thus, w is the nearest-neighbor of v if its feature vector has the smallest Euclidean distance to the feature vector of v, out of all the features in the set V. Ideally, the feature descriptors (vectors) of two corresponding features should be identical, since the two features correspond to the same physical point on the object. However, due to noise and other variations from one image to another, the feature vectors of two corresponding features may not be identical. In this case, the distance between feature vectors should still be relatively small compared to the distance between arbitrary features. Thus, the concept of nearest-neighbor features (also referred to as nearest-neighbor feature vectors) may be used to determine whether or not two features are correspondences or not (since corresponding features are much more likely to be nearest-neighbors than an arbitrary pairing of features).

### K-D Tree:

K-D tree is an efficient search structure, which applies the method of successive bisections of the data not in a single dimension (as in a binary tree), but in k dimensions. At each branch point, a predetermined dimension is used as the split direction. As with binary search, a k-D tree efficiently narrows down the search space: if there are N entries, it typically takes only log(N)/log(2) steps to get to a single element. The drawback to this efficiency is that if the elements being searched for are not exact replicas, noise may sometimes cause the search to go down the wrong branch, so some way of keeping track of alternative promising branches and backtracking may be useful. A k-D tree is a common method used to find nearest-neighbors of features in a search image from a set of features of object model images. For each feature in the search image, the k-D tree is used to find the nearest-neighbor features in the object model images. This list of potential feature correspondences serves as a basis for determining which (if any) of the modeled objects is present in the search image.

### Vector Quantization:

Vector quantization (VQ) is a method of partitioning an n-dimensional vector space into distinct regions, based on sample data from the space. Acquired data may not cover the space uniformly, but some areas may be densely represented, and other areas may be sparse. Also, data may tend to exist in clusters (small groups of data that occupy a sub-region of the space). A good VQ algorithm will tend to preserve the structure of the data, so that densely populated areas are contained within a VQ region, and the boundaries of VQ regions occur along sparsely populated spaces. Each VQ region can be represented by a representative vector (typically, the mean of the vectors of the data within that region). A common use of VQ is as a form of lossy compression of the data—an individual datapoint is represented by the enumerated region it belongs to, instead of its own (often very lengthy) vector.

### Codebook, Codebook Entry:

Codebook entries are representative enumerated vectors that represent the regions of a VQ of a space. The “codebook” of a VQ is the set of all codebook entries. In some data compression applications, initial data are mapped onto the corresponding VQ regions, and then represented by the enumeration of the corresponding codebook entry.

### Coarse-to-fine:

The general principle of coarse-to-fine is a method of solving a problem or performing a computation by first finding an approximate solution, and then refining that solution. For example, efficient optical-flow algorithms use image pyramids, where the image data is represented by a series of images at different resolutions, and motion between two sequential frames is first determined at a low resolution using the lowest pyramid level, and then that low resolution motion estimate is used as an initial guess to estimate the motion more accurately at the next higher resolution pyramid level.

I. System Overview

In one embodiment, an object recognition system is described that uses a two step approach to recognize objects. For example, a large database may be split into many smaller databases, where similar objects are grouped into the same small database. A first coarse classification may be performed to determine which of the small databases the object is likely to be in. A second refined search may then be performed on a single small database, or a subset of small databases, identified in the coarse classification to find an exact match. Typically, only a small fraction of the number of small databases may be searched. Whereas conventional recognition systems may return poor results if applied directly to the entire database, by combining a recognition system with an appropriate classification system, a current recognition system may be applied to a much larger database and still function with a high degree of accuracy and utility.

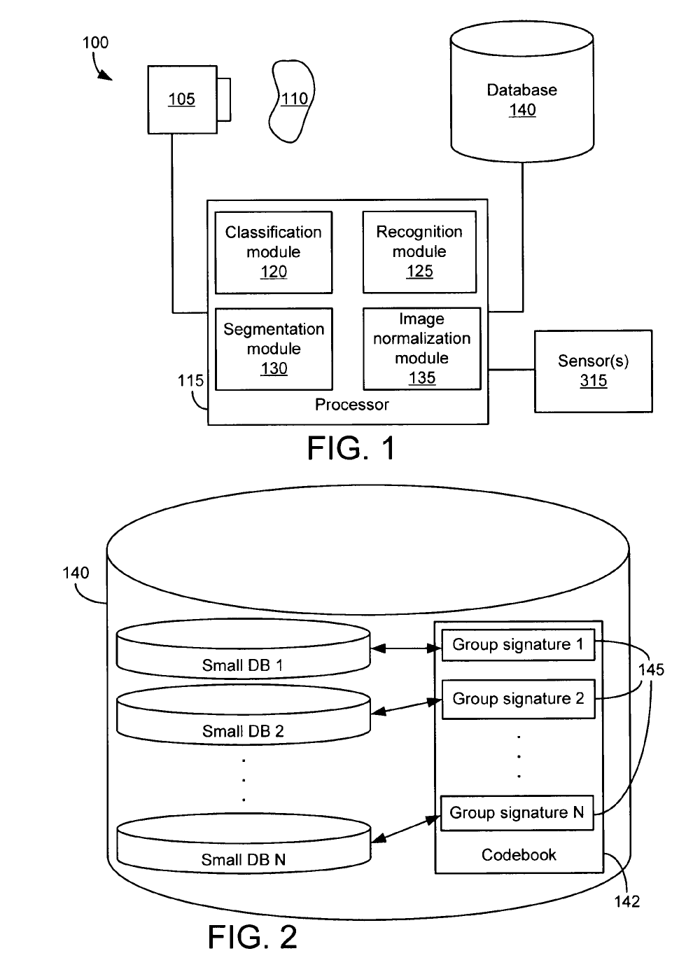

FIG. 1 is a block diagram of an object recognition system 100 according to one embodiment. In general, system 100 is configured to implement a two-step approach to object recognition. For example, system 100 may avoid applying a known object recognition algorithm directly to an entire set of known objects to recognize a target object (because of the size of the set of known objects, the algorithm may have poor results), but rather system 100 may operate by having the known objects grouped into subsets based on some measurement of object similarity. Then system 100 implements the two-step approach by: (1) identifying which subset of known objects the target object is similar to (e.g., object classification), and (2) then utilizing a known object recognition algorithm of the (much smaller) subset of known objects to attain highly accurate, useful results (e.g., object recognition).

System 100 may be used in various applications such as in merchandise checkout and image-based search applications on the Internet (e.g., recognizing objects in an image captured by a user with a mobile platform (e.g., cell phone)). System 100 includes an image capturing device 105 (e.g., a camera (still photograph camera, video camera)) to capture images (e.g., black and white images, color images) of a target object 110 to be recognized. Image capturing device 105 produces image data that represents one or more images of a scene within a field of view of image capturing device 105. In an alternative embodiment, system 100 does not include image capturing device 105, but receives image data produced by an image capturing device remote from system 100 (e.g., from a camera of a smart phone) through one or more various signal transmission mediums (e.g., wireless transmission, wired transmission). The image data are communicated to a processor 115 of system 100. Processor 115 includes various processing modules that analyze the image data to determine whether target object 110 is represented in an image captured by image capturing device 105 and to recognize target object 110.

For example, processor 115 includes an optional classification module 120 that is configured to generate a classification model for target object 110. Any type of classification model may be generated by classification module 120. In general, the classification module 120 uses the classification model to classify objects as belonging to a subset of a set of known objects. In one example, the classification model includes a classification signature derived from a measurement of one or more aspects of target object 110. In one embodiment, the classification signature is an n-dimensional vector. This disclosure describes in detail use of a classification signature to classify objects. However, skilled persons will recognize that the various embodiments described herein may be modified to implement any classification model that enables an object to be classified as belonging to a subset of known objects. Classification module 120 may include sub-modules, such as a feature detector to detect features of an object.

Processor 115 also includes a recognition module 125 that may include a feature detector. Recognition module 125 may be configured to receive the image data from image capturing device 105 and produce from the image data object model information of target object 110. In one embodiment, the object model of target object 110 includes a recognition model that enables target object 110 to be recognized. In one example, recognition means determining that target object 110 corresponds to a certain known object, and classification means determining that target object 110 belongs to a subset of known objects. The recognition model may correspond to any type of known recognition model that is used in a conventional object recognition system.

In one embodiment, the recognition model is a feature model (i.e., a feature-based model) that corresponds to a collection of features that are derived from an image of target object 110. Each feature may include different types of information associated with the feature and target object 110 such as an identifier to identify that the feature belongs to target object 110; the x and y position coordinates, scale and orientation of the feature; and a feature descriptor. The features may correspond to one or more of surface patches, corners and edges and may be scale, orientation and/or illumination invariant. In one example, the features of target object 110 may include one or more of different features such as, but not limited to, scale-invariant feature transformation (SIFT) features, described in U.S. Pat. No. 6,711,239; speeded up robust features (SURF), described in Herbert Bay et al., “SURF: Speeded Up Robust Features,” Computer Vision and Image Understanding (CVIU), Vol. 110, No. 3, pp. 346-359 (2008); gradient location and orientation histogram (GLOH) features, described in Krystian Mikolajczyk & Cordelia Schmid, “A performance evaluation of local descriptors,” IEEE Transactions on Pattern Analysis & Machine Intelligence, No. 10, Vol. 27, pp. 1615-1630 (2005); DAISY features, described in Engin Tola et al., “DAISY: An Efficient Dense Descriptor Applied to Wide Baseline Stereo,” IEEE Transactions on Pattern Analysis and Machine Intelligence, (2009); and any other features that encode the local appearance of target object 110 (e.g., features that produce similar results irrespective of how the image of target object 110 was captured (e.g., variations in illumination, scale, position and orientation)).

In another embodiment, the recognition model is an appearance-based model in which target object 110 is represented by a set of images representing different viewpoints and illuminations of target object 110. In another embodiment, the recognition model is a shape-based model that represents the outline and/or contours of target object 110. In another embodiment, the recognition model is a color-based model that represents the color of target object 110. In another embodiment, the recognition model is a 3-D structure model that represents the 3-D shape of target object 110. In another embodiment, recognition model is a combination of two or more of the different models identified above. Other types of models may be used for the recognition model. Processor 115 uses the classification signature and the recognition model to recognize target object 110 as described in greater detail below.

Processor 115 may include other optional modules, such as a segmentation module 130 that segments an image of target object 110 from an image of the scene captured by image capturing device 105 and an image normalization module 135 that transforms an image of target object 110 to a normalized, canonical form. The functions of modules 130 and 135 are described in greater detail below.

System 100 also includes a database 140 that stores various forms of information used to recognize objects. For example, database 140 contains object information associated with a set of known objects that system 100 is configured to recognize. The object information is communicated to processor 115 and compared to the classification signature and recognition model of target object 110 so that target object 110 may be recognized.

Database 140 may store object information corresponding to a relatively large number (e.g., thousands, tens of thousands, hundreds of thousands or millions) of known objects. Accordingly, database 140 is organized to enable efficient and reliable searching of the object information. For example, as shown in FIG. 2, database 140 is divided into multiple portions representing small databases (e.g., small database (DB) 1, small DB 2, . . . , small DB N). Each small database contains object information of a subset known objects that are similar. In one example, similarity between known objects is determined by measuring the Euclidean distance between classification model vectors representing the known objects as is understood by skilled persons. In one illustrative example, database 140 contains object information of about 50,000 objects, and database 140 is divided into 50 small databases, each containing object information of about 1,000 objects. In another illustrative example, database 140 contains object information of five million objects, and database 140 is divided into 1,000 small databases, each containing object information of about 5,000 objects. Database 140 optionally includes a codebook 142 that stores group signatures 145 associated with ones of the small databases (e.g., group signature 1 is associated with small DB 1) and ones of classification signature groups described in greater detail below. Each of the group signatures 145 are derived from the object information contained in its associated small database. Group signature 145 of a small database is one example of a representative classification model of the small database.

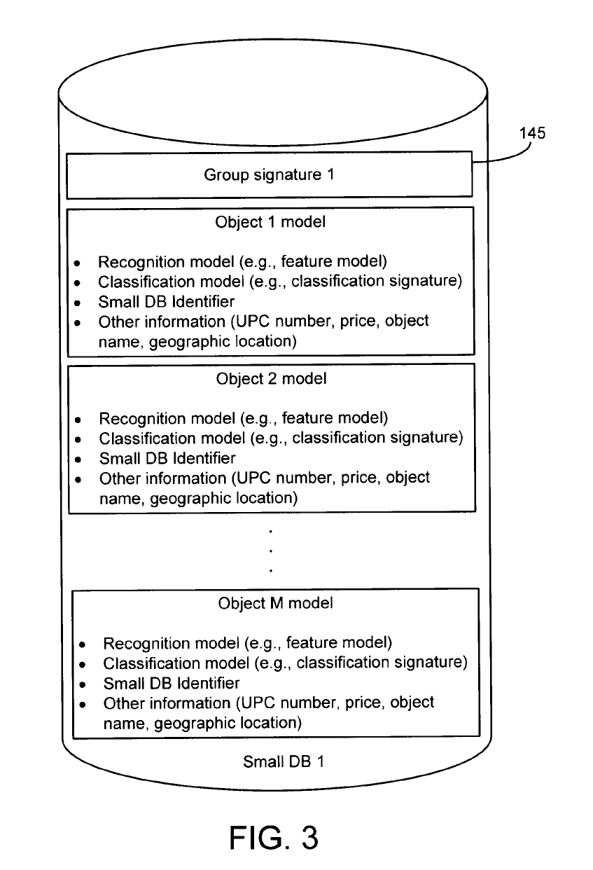

FIG. 3 is a block diagram representation of small DB 1 of database 140. Each small database may include a representation of its group signature 145. Small DB 1 includes object information of M known objects, and group signature 145 of small DB 1 is derived from the object information of the M known objects contained in small DB 1. In one example, group signature 145 is a codebook entry of codebook 142 stored in database 140 as shown in FIG. 2. During an attempt to recognize target object 110, group signatures 145 of the small databases are communicated to processor 115, and classification module 120 compares the classification signature of target object 110 to group signatures 145 to select one or more small databases to search to find a match for target object 110. Group signatures 145 are described in greater detail below.

The object information of the M known objects contained in small DB 1 corresponds to object models of the M known objects. Each known object model includes various types of information about the known object. For example, the object model of known object 1 includes a recognition model of known object 1. The recognition models of the known objects are the same type of model as the recognition model of target object 110. In one example, the recognition models of the known objects are feature models that correspond to collections of features derived from images of the known objects. Each feature of each known object may include different types of information associated with the feature and its associated known object such as an identifier to identify that the feature belongs to its known object; the x and y position coordinates, scale and orientation of the feature; and a feature descriptor. The features of the known objects may include one or more different features such as SIFT features, SURF, GLOH features, DAISY features and other features that encode the local appearance of the object (e.g., features that produce similar results irrespective of how the image was captured (e.g., variations in illumination, scale, position and orientation)). In other embodiments, the recognition models of the known objects may include one or more of appearance-based models, shape-based models, color-based models and 3-D structure based models. The recognition models of the known objects are communicated to processor 115, and recognition module 125 compares the recognition model of target object 110 to the recognition models of the known objects to recognize target object 110.

Each known object model also includes a classification model (e.g., a classification signature) of its known object. For example, the object model of known object 1 includes a classification signature of object 1. The classification signatures of the known objects are obtained by applying the measurement to the known objects that is used to obtain the classification signature of target object 110. The known object models of the known objects may also include a small DB identifier that indicates that the object models of the known objects are members of their corresponding small database. Typically, the small DB identifiers of the known object models in a particular small database are the same and distinguishable from the small DB identifiers of the known object models in other small databases. The object models of the known objects may also include other information that is useful for the particular application. For example, the object models may include UPC numbers of the known objects, the names of the known objects, the prices of the known objects, the geographical location (e.g., if the object is a landmark or building) and any other information that is associated with the objects.

System 100 enables a two-step approach for recognizing target object 110. In general, the classification model of target object 110 is compared to representative classification models of the small databases to determine whether target object 110 likely belongs to one or more particular small databases. In one specific example, a first coarse classification is done using the classification signature of target object 110 and group signatures 145 to determine which of the multiple small databases likely includes a known object model that corresponds to target object 110. A second refined search is then performed on the single small database, or a subset of the small databases, identified in the coarse classification to find an exact match. In one example, only a very small fraction of the number of small databases may need to be searched, in contrast to other conventional methods. System 100 may provide a high rate of recognition without requiring a linear increase in either computation time or hardware usage.

II. Database Division

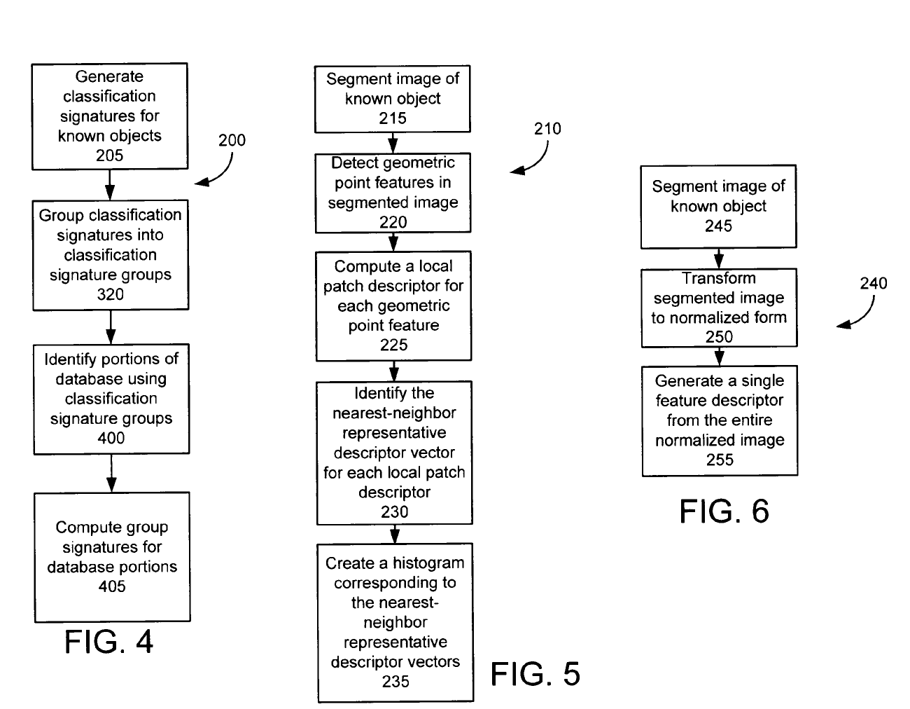

FIG. 4 is a flowchart of a method 200, according to one embodiment, to divide database 140 into multiple portions representing smaller databases that each contain recognition models of a subset of the set of known objects represented in database 140. Preferably, database 140 is divided prior to recognizing target objects. For each known object, a classification model, such as a classification signature, of the known object is generated by applying a measurement to the known object (step 205). In one example, the classification signature is an N-dimensional vector quantifying one or more aspects of the known object. The measurement should be discriminative enough to enable database 140 to be segmented into smaller databases that include object models of similar known objects and to enable a small database to be identified that a target object likely belongs to. For example, the classification signature of an object may be a normalized 100-dimension vector and the similarity of two objects may be computed by calculating the norm of the difference of the two classification signatures (e.g., calculating the Euclidean distance between the two classification signatures). The classification signature may be deemed discriminative enough if, for any given object, there is a small subset of other objects that have a small distance to the classification signature (e.g., only 1% of the other objects have a Euclidean distance norm of <0.1) compared to the average distance of the classification signature to all objects (e.g., the average Euclidean distance is 0.7). However, in one example, the measurement need not be so discriminative so as to enable a target object/known object match (e.g., object recognition) based exclusively on the classification signatures of target object 110 and the known objects. What is deemed to be discriminative enough may determined by a user and may vary based on different factors including the particular application in which system 100 is implemented.

Several object parameters can be used for the measurement. Some of the object parameters may be physical properties of the known object, and some of the object parameters may be extracted from the appearance of the known object in a captured image. Possible measurements include:
Weight, and/or moments of inertia;
Shape;

Size (height, width, length, or combination);

Geometric moments;

Volume (even if it is not a box shape);

Measures of curvature;

Detection of flat versus curved objects;
Electromagnetic characteristics (magnetic permeability, inductance, absorption, transmission);
Temperature;
Image measurements of the known object;

Color measurements, color statistics and/or color histogram;

Texture and/or spatial frequency measurements;

Shape measurements;
Curvature, eccentricity;
Illumination invariant image properties (e.g., statistics);
Illumination invariant image gradient properties (e.g., statistics);
A feature (e.g., a SIFT-like feature) corresponding to the entire area, or a large portion, of the image of the known object;
Accumulated measurements and/or statistics over multiple regions of interest within the image of the known object;
Accumulated measurements and/or statistics of SIFT features or other local features (e.g., a histogram or statistics of the distribution of one or more of position, scale and orientation of the features); and
Histogram of frequency of vector-quantized SIFT feature descriptors or other local feature descriptors.

Specific examples of measurements are provided below with reference to FIGS. 5-8.

FIG. 5 is a flowchart of a method 210, according to one example, for determining a classification signature of the known object. Method 210 uses appearance characteristics obtained from an image of the known object. The image of the known object is segmented from an image of a scene by segmentation module 130 so that representations of background or other objects do not contribute to the classification signature of the known object (step 215). In other words, the image of a scene is segmented to produce an isolated image of the known object. Step 215 is optional. For example, the known object may occupy a large portion of the image such that the effect of the background may be negligible or features to be extracted from the image may not exist in the background (e.g., by design of the feature detection process or by design of the background). Various techniques may be used to segment the image of the known object. For example, suitable segmentation techniques include, but are not limited to:
Segmentation based on texture differences/similarities;
Segmentation based on anisotropic diffusion and detection of strong boundaries/edges;
Segmentation using active lighting;

Gray-encoded sequence of 2-d projected patterns plus imager;

Laser line triangulation, scanning done by moving platform;
Segmentation based on range/depth sensor information;

2-D, 1-D scanning with object motion or spot range sensor;

Infrared or laser triangulation;

Time-of-flight measurements;

Infrared reflection intensity measurements;
Segmentation based on stereo camera pair information;

Dense stereo matching;

Sparse stereo matching;
Segmentation based on images from multiple cameras;

3-D structure estimation;
Segmentation based on consecutive images of the known object captured when the object moves;

Motion/blob tracking;

Dense stereo matching;

Dense optical flow;
Segmentation based on a video sequence of the known object;

Motion/blob tracking;

dense stereo matching;

dense optical flow;
Background subtraction;
Special markings on the known object that allow it to be located (but not necessarily recognized); and
Utilizing a simplified or known background that is distinguishable from the known object in the foreground.

Once the image of the known object is segmented, geometric point features are detected in the segmented image of the known object (step 220). A local patch descriptor or feature vector is computed for each geometric point feature (step 225). Examples of suitable local patch descriptors include, but are not limited to, SIFT feature descriptors, SURF descriptors, GLOH feature descriptors, DAISY feature descriptors and other descriptors that encode the local appearance of the object (e.g., descriptors that produce similar results irrespective of how the image was captured (e.g., variations in illumination, scale, position and orientation)). In a preferred embodiment, prior to method 210, a feature descriptor vector space in which the local patch descriptors are located is divided into multiple regions, and each region is assigned a representative descriptor vector. In one embodiment, the representative descriptor vectors correspond to first-level VQ codebook entries of a first-level VQ codebook, and the first-level VQ codebook entries quantize the feature descriptor vector space. After the local patch descriptors of the known object are computed, each local patch descriptor is compared to the representative descriptor vectors to identify a nearest-neighbor representative descriptor vector (step 230). The nearest-neighbor representative descriptor vector identifies which region the local patch descriptor belongs to. A histogram is then created by tabulating for each representative descriptor vector the number of times it was identified as the nearest-neighbor of the local patch descriptors (step 235). In other words, the histogram quantifies how many local patch descriptors belong in each region of the feature descriptor vector space. The histogram is used as the classification signature for the known object.

FIG. 6 is a flowchart of a method 240, according to another example, for determining a classification signature of the known object. Method 240 uses appearance characteristics obtained from an image of the known object. The image of the known object is segmented from an image of a scene so that representations of background or other objects do not contribute to the classification signature of the known object (step 245). Step 245 is optional as discussed above with reference to step 215 of method 210. One or more of the segmentation techniques described above with reference to method 210 may be used to segment the image of the known object.

Next, image normalization module 135 applies a geometric transform to the segmented image of the known object to generate a normalized, canonical image of the known object (step 250). Step 250 is optional. For example, the scale and orientation at which the known object is imaged may be configured such that the segmented image represents the known object at a desired scale and orientation without applying a geometric transform. Various techniques may be used to generate the normalized image of the known object. In one embodiment, the desired result of a normalizing technique is to obtain the same, or nearly the same, image representation of the known object regardless of the initial scale and orientation with which the known object was imaged. Various examples of suitable normalizing techniques are described below.

In one approach, a normalizing scaling process is applied, and then a normalizing orientation process is applied to obtain the normalized image of the known object. The normalizing scaling process may vary depending on the shape of the known object. For example, for a known object that has faces that are rectangular shaped, the image of the known object may be scaled in the x and y directions separately so that the resulting image has a pre-determined size in pixels (e.g., 400×400 pixels).

For a known object that does not have rectangular shaped faces, a major axis and a minor axis of the object in the image may be estimated, where the major axis denotes the direction of the largest extent of the object and the minor axis is perpendicular to the major axis. The image may then be scaled along the major and minor axes such that the resulting image has a pre-determined size in pixels.

After the normalizing scaling process is applied, the orientation of the scaled image is adjusted by measuring the strength of the edge gradients in four axis directions and rotating the scaled image so that the positive x direction has the strongest gradients. Alternatively, gradients may be sampled at regular intervals along 360° of a plane of the scaled image and the direction of the strongest gradients become the positive x-axis. For example, gradient directions may be binned in 15 degree increments, and for each small patch of the scaled image (e.g., where the image is subdivided into a 10×10 grid of patches), the dominant gradient direction may be determined. The bin corresponding to the dominant gradient direction is incremented, and after the process is applied to each grid patch, the bin with the largest count becomes the dominant orientation. The scaled object image may then be rotated so that this dominant orientation is aligned with the x-axis of the image or the dominant orientation may be taken into account implicitly without applying a rotation to the image.

After the segmented image of the known object is normalized, the entire normalized image, or a large portion of it, is used as a patch region from which a feature (e.g., a single feature) is generated (step 255). The feature may be in the form of one or more various features such as, but not limited to, a SIFT feature, a SURF, a GLOH feature, a DAISY feature and other features that encode the local appearance of the object (e.g., features that produce similar results irrespective of how the image was captured (e.g., variations in illumination, scale, position and orientation)). When the entire known object is represented by a single feature descriptor, it may be beneficial to extend the feature descriptor to represent the known object in more detail and with more dimensions. For example, whereas the typical SIFT descriptor extraction method partitions a patch into a 4×4 grid to generate a SIFT vector with 128 dimensions, method 240 may partition the patch region into a larger grid (e.g., 16×16 elements) to generate a SIFT-like vector with more dimensions (e.g., 2048 elements). The feature descriptor is used as the classification signature of the known object.

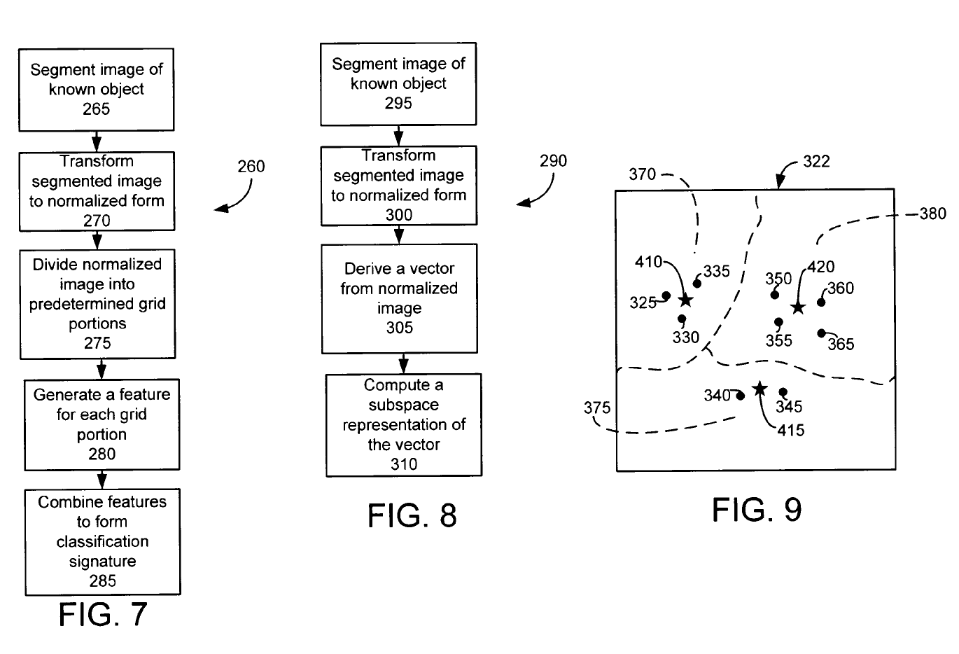

FIG. 7 is a flowchart of a method 260, according to another example, for determining a classification signature of the known object. Method 260 uses appearance characteristics obtained from an image of the known object. The image of the known object is segmented from an image of a scene so that representations of background or other objects do not contribute to the classification signature of the known object (step 265). Step 265 is optional as discussed above with reference to step 215 of method 210. One or more of the segmentation techniques described above with reference to method 210 may be used to segment the image of the known object.

Next, a geometric transform is applied to the segmented image of the known object to generate a normalized, canonical image of the known object (step 270). Step 270 is optional as discussed above with reference to step 250 of method 240. The image normalization techniques described above with reference to method 240 may be used to generate the normalized, canonical image of the known object. A predetermined grid (e.g., 10×10 blocks) is applied to the normalized image to divide the image into grid portions (step 275). A feature (e.g., a single feature) is then generated for each grid portion (step 280). The features of the grid portions may be in the form of one or more various feature such as, but not limited to, SIFT features, SURF, GLOH features, DAISY features and other features that encode the local appearance of the object (e.g., descriptors that produce similar results irrespective of how the image was captured (e.g., variations in illumination, scale, position and orientation)). Each feature may be computed at a predetermined scale and orientation, at multiple scales and/or multiple orientations, or at a scale and an orientation that maximize the response of a feature detector (keeping the feature x and y coordinates fixed).

The collection of feature descriptors for the grid portions are then combined to form the classification signature of the known object (step 285). The feature descriptors may be combined in several ways. In one example, the feature descriptors are concatenated into a long vector. The long vector may be projected onto a lower dimensional space using principal component analysis (PCA) or some other dimensionality reduction technique. The technique of PCA is known to skilled persons, but an example of an application of PCA to image analysis can be found in Matthew Turk & Alex Pentland, “Face recognition using eigenfaces,” Proc. IEEE Conference on Computer Vision and Pattern Recognition, pp. 586-591 (1991).

Another method to combine the features of the grid portions is to use aspects of the histogram approach described in method 210. Specifically, the features of the grid portions are quantized according to a vector quantized partition of the feature space, and a histogram representing how many of the quantized features from the grid portions belong to each partition of the feature space is used as the classification signature. In one example, the feature space of the features may be subdivided into 400 regions, and thus the histogram to be used as the classification signature of the known object would have 400 entries. In this method, as well as in other parts of the disclosure where the process of histogramming or binning is described, the method of soft-binning may be applied. In soft-binning, the full vote of a sample (e.g., feature descriptor) is not assigned entirely to a single bin, but is proportionally distributed amongst a subset of nearby bins. In this particular example, the proportions may be made according to the relative distance of the feature descriptor to the center of each bin (in feature descriptor space) in such a way that the total sums to 1.

FIG. 8 is a flowchart of a method 290, according to another example, for determining a classification signature of the known object. Method 290 uses appearance characteristics obtained from an image of the known object. The image of the known object is segmented from an image of a scene so that representations of background or other objects do not contribute to the classification signature of the known object (step 295). Step 295 is optional as discussed above with reference to step 215 of method 210. One or more of the segmentation techniques described above with reference to method 210 may be used to segment the image of the known object.

Next, a geometric transform is applied to the segmented image of the known object to generate a normalized, canonical image of the known object (step 300). Step 300 is optional as discussed above with reference to step 250 of method 240. The image normalization techniques described above with reference to method 260 may be used to generate the normalized, canonical image of the known object. A vector is derived from the entire normalized image, or a large portion of it (step 305). For example, the pixels values of the normalized image are concatenated to form the vector. A subspace representation of the vector is then computed (e.g., the vector is projected onto a lower dimension) and used as the classification signature of the known object (step 310). For example, PCA may be implemented to provide the subspace representation. In one example, a basis for the PCA representation may be created by:
Using normalized images of all the known objects that are represented in database 140 to derive the vectors for the known objects;
Normalizing the vectors (removing the mean, and either applying a constant scaling factor to all vectors, or normalizing each to be unit norm); and
Computing a singular value decomposition (SVD) of the vectors, and using the N top right-hand vectors as a basis.

Further details of PCA and SVD are understood by skilled persons. For any new known object or target object to be recognized, the normalized vector of the new object is projected onto the PCA basis to generate an N-dimensional vector that may be used as the classification signature of the new known object.

In another example for determining a classification signature of the known object, one or more physical property measurements of the known object is used for the classification signature. To obtain the physical property measurements, system 100 may include one or more optional sensors 315 to measure, for example, the weight, size, volume, shape, temperature, and/or electromagnetic characteristics of the known object. Alternatively, system 100 may communicate with sensors that are remote from system 100 to obtain the physical property measurements. Sensors 315 produce sensor data that is communicated to and used by classification module 120 to derive the classification signature. If image-based depth or 3-D structure estimation is used to segment the object from the background as described in steps 215, 245, 265 and 295 of methods 210, 240, 260 and 290, then size (and/or volume) information may be available (either in metrically calibrated units or arbitrary units, depending on whether or not the camera system that captured the image of the known object is metrically calibrated) for combination with the appearance-based information, without the need of a dedicated size or volume sensor.

The sensor data can be combined with appearance-based information representing appearance characteristics of the known object to form the classification signature. In one example, the physical property measurement represented in the sensor data is concatenated with the appearance-based information obtained using one or more of methods 210, 240, 260 and 290 described with reference to FIGS. 5-8 to form a vector. The components of the vector may be scaled or weighted so as to control the relative effect or importance of each subpart of the vector. In this way, database 140 can be separated into small databases in one homogeneous step, considering physical property measurements and appearance-based information at once.

Instead of combining the sensor data with the appearance-based information to form the classification signature of the known object, the appearance-based information may be used as the classification signature that is used to initially divide database 140 into small databases (described in greater detail below with reference to FIG. 4), and the sensor data can be used to further divide the small databases. Or, the sensor data can be used to form the classification signature that is used to initially divide database 140 into smaller databases, which are then further divided using the appearance-based information.

Returning to FIG. 4, once the classification signatures of the known objects are generated, the classification signatures are grouped into multiple classification signature groups (step 320). A classification signature group is one example of a more general classification model group. FIG. 9 is an arbitrary graph representing a simplified 2-D classification signature space 322 in which the classification signatures of the known objects are located. Points 325, 330, 335, 340, 345, 350, 355, 360 and 365 represent the locations of classification signatures of nine known objects in classification signature space 322. Points 325, 330, 335, 340, 345, 350, 355, 360 and 365 are grouped into three different classification signature groups 370, 375 and 380 having boundaries represented by the dashed lines. Specifically, classification signatures represented by points 325, 330 and 335 are members of classification signature group 370; classification signatures represented by points 340 and 345 are members of classification signature group 375; and classification signatures represented by points 350, 355, 360 and 365 are members of classification signature group 380. Skilled persons will recognize that FIG. 9 a simplified example. Typically, system 100 may be configured to recognize significantly more than nine known objects, the feature space has more than two dimensions and classification signature space 322 may be divided into more than three groups.

The grouping may be performed using various different techniques. In one example, the classification signatures are clustered into classification signature groups using a clustering algorithm. Any known clustering algorithm may be implemented. Suitable clustering algorithms include a VQ algorithm and a k-means algorithm. Another algorithm is an expectation-maximization algorithm based on a mixture of Gaussians model of the distribution of classification signatures in classification signature space. The details of clustering algorithms are understood by skilled persons.

In one example, the number of classification signature groups may be selected prior to clustering the classification signatures. In another example, the clustering algorithm determines during the clustering how many classification signature groups to form. Step 320 may also include soft clustering techniques in which a classification signature that is within a selected distance from the boundary of adjacent classification signature groups is a member of those adjacent classification signature groups (i.e., the classification signature is associated with more than one classification signature group). For example, if the distance of a classification signature to a boundary of an adjacent group is less than twice the distance to the center of its own group, the classification signature may be included in the adjacent group as well.

As shown in FIG. 4, once the multiple classification signature groups are formed, the classification signature groups may be used to identify corresponding portions of database 140 that form the small databases (step 400). In the simplistic example of FIG. 9, three portions of database 140 are identified corresponding to classification signature groups 370, 375 and 380. In other words, three small databases are formed from database 140. A first one of the small databases corresponding to classification signature group 370 contains the object models of the known objects whose classification signatures are represented by points 325, 330 and 335; a second one of the small databases corresponding to classification signature group 375 contains the object models of the known objects whose classification signatures are represented by points 340 and 345; and a third one of the small databases corresponding to classification signature group 380 contains the object models of the known objects whose classification signatures are represented by points 350, 355, 360 and 365. In one example, identifying the portions of the database (i.e., forming the small databases) corresponds to generating the small DB identifiers for the known object models (shown in FIG. 3).

A group signature 145 is computed for each classification signature group or, in other words, for each database portion (i.e., small database) (step 405). Group signatures 145 need not be computed after the database portions are identified, but may be computed before or during identification of the database portions. Group signature 145 is one example of a more general representative classification model. Groups signatures 145 are derived from the classification signatures in the classification signature groups. In the simplistic example of FIG. 9, group signatures 145 of classification signature groups 370, 375 and 380 are represented by stars 410, 415 and 420, respectively. Group signature 145 represented by star 410 is derived from the classification signatures represented by points 325, 330 and 335; group signature 145 represented by star 415 is derived from the classification signatures represented by points 340 and 345; and group signature 145 represented by star 420 is derived from the classification signatures represented by points 350, 355, 360 and 365. In one example, group signatures 145 correspond to the mean of the classification signatures (e.g., group signature 145 represented by star 410 is the mean of the classification signatures represented by points 325, 330 and 335). In another example, group signature 145 may be computed as the actual classification signature from a known object that is closest to the computed mean signature. In another example, group signature 145 may be represented by listing all the classification signatures of the known objects of the group that are on the boundary of the convex hull containing all of the known objects in the group (i.e., the classification signatures that define the convex hull). In this example, a new target object would be determined to belong to a particular group of its classification signature is inside the convex hull of the group. Group signatures 145 may serve as codebook entries of codebook 142 that is searched during recognition of target object 110.

III. Target Object Recognition

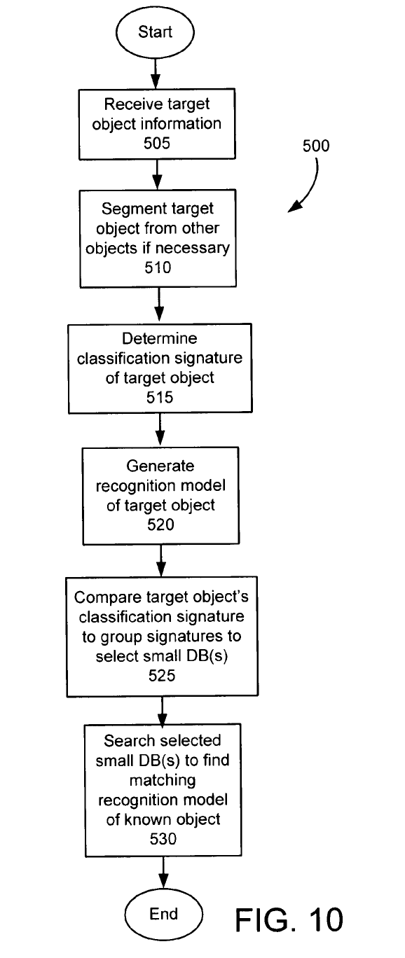

FIG. 10 is a flowchart of a method 500, according to one embodiment, for recognizing target object 110 using database 140 that has been divided as described above. Processor 115 receives information corresponding to target object 110 (step 505). This information includes image data representing an image in which target object 110 is represented. The information may also include sensor data (e.g., weight data, size data, temperature data, electromagnetic characteristics data). Under some circumstances, other objects may be represented in the image of target object 110, and one may desire to recognize the other objects. In this case the image may optionally be segmented (step 510) by segmentation module 130 into multiple separate objects, using one or more of the following methods:
Implement a range/depth sensor and detect discontinuities in range/depth sensor data and piecewise-continuous segments;
Use multiple cameras with multiple viewpoints, and pick one without discontinuities in associated range/depth sensor data; and
build a 3-D volumetric model of objects based on multiple observations (with a single camera or multiple cameras and multiple view or motion-based structure estimation, with one or more range sensors, or with a combination of cameras and range sensors) and then perform piecewise continuous segmentation of the 3-D volumetric model.

The image of target object 110 may also be segmented from the background of the image and normalized using one or more of the normalizing techniques described above. From the target object information received by processor 115, classification module 120 determines a classification signature of target object 110 by applying a measurement to one or more aspects of target object that is represented in the target object information (step 515). Any of the measurements and corresponding methods described above (e.g., the methods corresponding to FIGS. 5-8) that may be used to determine the classification signatures of the known objects may also be used to determine the classification signature of target object 110. Preferably, the measurement(s) used to obtain the classification signature of target object 110 are the same as the measurement(s) used to obtain the classification signatures of the known objects. Before, after or simultaneously with step 515, recognition module 125 uses the image data representing an image of target object 110 to generate the recognition model of target object 110 (step 520). In one example, the recognition model is a feature model, and the various types of features that may be generated for the feature model of target object 110 are described above.

After the classification signature of target object 110 is determined, classification module 120 compares the classification signature of target object 110 to group signatures 145 of the small databases of database 140 (step 525). This comparison is performed to select a small database to search. In one example, the comparison includes determining the Euclidean distance between the classification signature of target object 110 and each of group signatures 145. If components of the classification signature and components of group signatures 145 are derived from disparate properties of target object 110 and the known objects, a weighted distance may be used to emphasize or de-emphasize particular components of the signatures. The small database selected for searching may be the one with the group signature that produced the shortest Euclidean distance in the comparison. In an alternative embodiment, instead of finding a single small database, a subset of small databases is selected. One way to select a subset of small databases is to take the top results from step 525. Another way is to have a predefined confusion table (or similarity table) which can provide a list of small databases with similar known objects given any one chosen small database.

After the small database(s) is/are selected, recognition module 125 searches the small database(s) to find a recognition model of a known object that matches the recognition model of target object 110 (step 530). A match indicates that target object 110 corresponds to the known object with the matching feature model. Step 530 is also referred to as refined recognition. Once the size of the search space has been reduced to a single database or a small subset of databases in step 525, any viable, reliable, effective method of object recognition may be used. For example, some recognition methods may not be viable in conjunction with searching a relatively large database, but may be implemented in step 530 because the search space has been reduced. Many known object recognition methods described herein (such as the method described in U.S. Pat. No. 6,711,293 directed to SIFT) use a feature model, but other types of object recognition methods may be used that use models other than feature models (e.g., appearance-based models, shape-based models, color-based models, 3-D structure based models). Accordingly, a recognition model as described herein may correspond to any type of model that enables matches to be found after the search space has been reduced.

In an alternative embodiment, instead of comparing the classification signature of target object 110 to group signatures 145 to select one or more small databases, the classification signature of target object 110 is compared to the classification signatures of the known objects to select the known objects that are most similar to target object 110. A small database is then created that contains the recognition models of the most similar known objects, and that small database is searched using the refined recognition to find a match for target object 110.

In another alternative embodiment, information from multiple image capturing devices may be used to recognize target object 110. For example, to make the measurement for the classification signature of target object 110 more discriminative, areas from different views of multiple image capturing devices are stitched/appended to cover more sides of target object 110. In another example, images from the multiple image capturing devices may be used separately to make multiple attempts to recognize target object 110. In another example, each image from the multiple image capturing devices may be used for a separate recognition attempt in which multiple possible answers from each recognition are allowed. Then the multiple possible answers are combined (via voting, a logical AND operation, or another statistical or probabilistic method) to determine the most likely match.

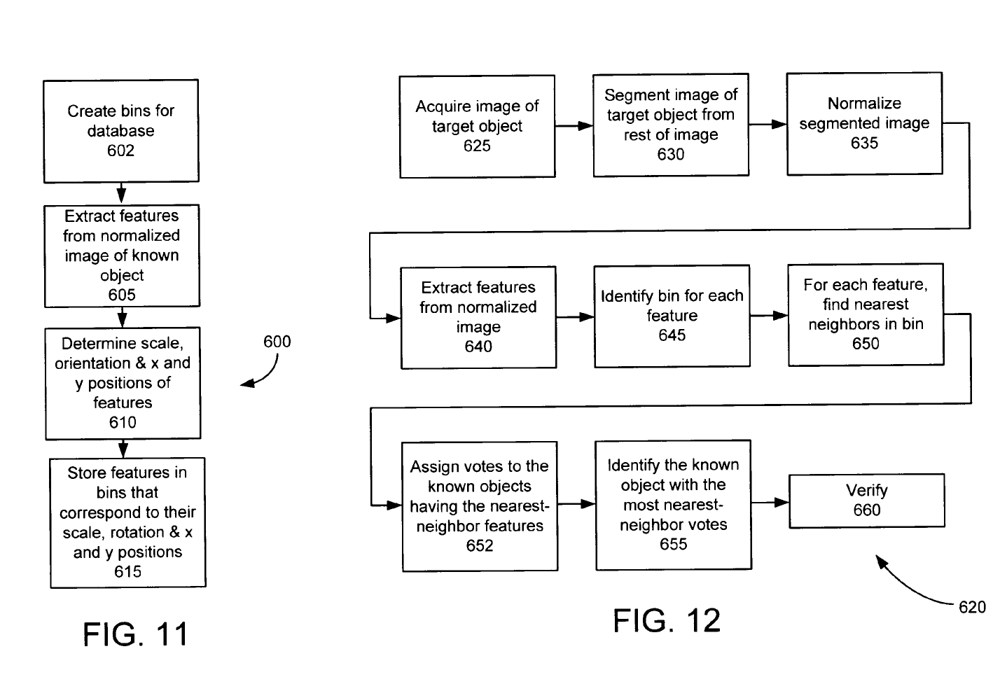

Another alternative embodiment to recognize target object 110 is described below with reference to FIGS. 11 and 12. In this alternative embodiment, a normalized image of target object 110 and normalized images of the known objects are used to perform recognition.

Database 140 is represented by a set of bins which cover the x and y positions, orientation, and scale at which features in normalized images of the known objects are found. FIG. 11 is a flowchart of a method 600 for populating the set of bins of database 140. First, bins are created for database 140 in which each bin corresponds to a selected x position, y position, orientation and scale of features of a normalized image (step 602). The x position, y position, orientation and scale space of the features is quantized or partitioned to create the bins. For each known object to be recognized, the features are extracted from the image of the known object (step 605). For each feature, its scale, orientation, and x and y positions in the normalized image are determined (step 610). Each feature is stored in a bin of database 140 that represents its scale, orientation, and x and y positions (step 615). The features stored in the bins may include various types of information including feature descriptors of the features, an identifier to identify the known object from which it was derived, and the actual scale, orientation and x and y positions of the feature.

In one example, scale may be quantized into 7 scale portions with a geometric spacing of 1.5× scaling magnification; orientation may be quantized into 18 portions of 20 degrees of width, and x and y positions may each be quantized into portions of 1/20th the width and the height of the normalized image. This example would give a total of 7*18*20*20=50,400 bins. Each bin thus stores, on average, approximately 1/50,000th of all the features of database 140. The scale, orientation and x and y positions may be quantized into a different number (e.g., a greater number, a lesser number) of portions than that presented above to result in a different total number of bins. Moreover, to counteract the effects of discretization produced by binning, a feature may be assigned to more than one bin (e.g., adjacent bins in which the values of one or more of the bin parameters (i.e., x position, y position, orientation and scale) are separated by one step). In this soft-binning approach, if the bin parameters of a feature place it near a boundary (in x position, y position, orientation and scale space) between adjacent bins, the feature may be in more than one bin so that the feature is not missed during a search for a target object. In one example, the x position, y position, orientation and scale of a feature may vary between observed images due to noise and other differences in the images, and soft-binning may compensate for these variations.

Each bin can be used to represent a small database, and nearest-neighbor searching for the features of target object 110 may be performed according to a method 620 represented in the flowchart of FIG. 12. An image of target object 110 is acquired and transmitted to processor 115 (step 625). Segmentation module 130 segments the image of target object 110 from the rest of the image using one or more of the segmentation techniques described above (step 630). Step 630 is optional as discussed above with reference to step 215 of method 210. Image normalization module 135 normalizes the segmented image of target object using one of the normalizing techniques described above (step 635). Step 630 is optional as discussed above with reference to step 250 of method 240. Recognition module 125 extracts features of target object 110 from the normalized image (step 640). Various types of features may be extracted including SIFT features, SURF, GLOH features and DAISY features.

Recognition module 125 determines the scale, orientation and x and y positions of each feature and an associated bin is identified for each feature based on its scale, orientation and x and y positions (step 645). As exemplified above, scale space can be quantized into 7 scale portions with a geometric spacing of 1.5×, orientation space can be quantized into 18 portions having 20 degree widths, and x and y position spaces can be quantized into bins of 1/20th the width and the height of the normalized image, which would give a total of 7*18*20*20=50,400 bins.

For each feature of target object 110, the bin identified for that feature is searched to find the nearest-neighbors (step 650). Then each of the known objects corresponding to nearest-neighbors identified receives a vote (step 652). Because each bin may contain a small fraction of the total number of features from the entire database 140 (e.g., around 50,000 in the example described above), nearest-neighbor matching may be done reliably, and the overall method 620 may result in reliable recognition when database 140 contains 50,000 times more known object models than would be possible if known object features were not separated into bins. It may be beneficial to search and vote for more than one nearest-neighbor because multiple different known objects may contain the same feature (e.g., multiple different known objects that are produced by one company and that include the same logo). In one example, all nearest-neighbors that are within a selected ratio distance from the closest nearest-neighbor are voted for. The selected ratio distance may be determined by a user to provide desired results for a particular application. In one example, the selected ratio distance may be a factor of 1.5 times the distance of the closest nearest-neighbor.

After the nearest-neighbors of the target object's features are found, the votes for the known objects are tabulated to identify the known object with the most votes (step 655). The known object with the most votes is highly likely to correspond to target object 110. The confidence of the recognition may be measured with an optional verification step 660 (such as doing one or more of a normalized image correlation, an edge-based image correlation test and computing a geometric transformation that maps the features of the target object onto the corresponding features of the matched known object). Alternatively, if there is more than one known object with a significant number of votes, the correct known object may be selected based on verification step 660.

As an alternative to step 650, to reduce the amount of storage space required for the entire database 140, each bin includes an indication as to which known objects have a feature that belongs to the bin without actually storing the features or feature descriptors of the known objects in the bin. Moreover, instead of doing a nearest-neighbor search of the features of the known objects, step 650 would involve voting for all known objects that have a feature that belongs to the bin identified by the feature of target object 110.

As another alternative to step 650, the amount of storage space required for database 140 may be reduced by using a coarser feature descriptor of lower dimensionality for the features of the objects. For example, instead of the typical 128-dimensional (represented as 128 bytes of memory) feature vector of a SIFT feature, a coarser feature descriptor with, for example, only 5 or 10 dimensions may be generated. This coarser feature descriptor may be generated by various methods, such as a PCA decomposition of a SIFT feature, or an entirely separate measure of illumination, scale, and orientation invariant properties of a small image patch centered around a feature point location (as SIFT, GLOH, DAISY, SURF, and other feature methods do).

In some of the variations of method 620, the method may produce a single match result, or a very small subset (for example, less than 10) of candidate object matches. In this case, optional verification step 660 may be sufficient to recognize target object 110 with a high level of confidence.

In other variations of method 620, the method may produce a larger number of potential candidate matches (e.g., 500 matches). In such cases, the set of candidate known objects may be formed into a small database for a subsequent refined recognition process, such as one or more of the process described in step 530 of method 500.

Another alternative embodiment to recognize target object 110 is described below. This alternative embodiment may be implemented without segmenting representations of target object 110 and known objects from their corresponding images. In this embodiment, a coarse database is created from database 140 using a subset of features of all the recognition models of the known objects in database 140. A refined recognition process, such as one or more of the process described in step 530 of method 500, may be used in conjunction with the coarse database either to select a subset of recognition models to analyze even further, or to recognize target object 110 outright. In one example, if the coarse database uses on average 1/50th of the features of a recognition model, then recognition can be performed on a database that is 50× larger than otherwise possible.

The coarse database can be created by selecting the subset of features in a variety of ways such as (1) selecting the most robust or most representative features of the recognition model of each known object and (2) selecting features that are common to multiple recognition models of the known objects.

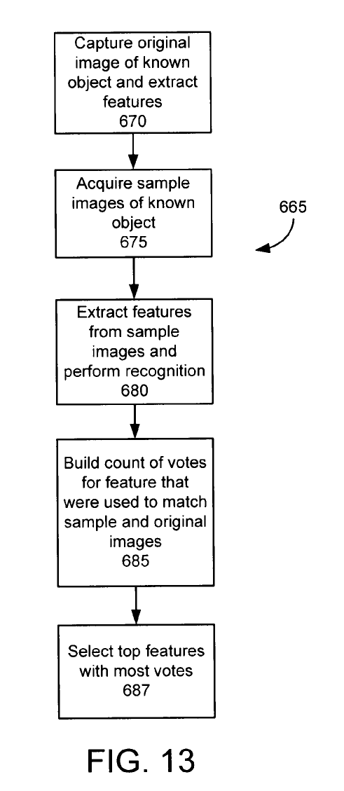

Selecting the most robust or most representative features may be implemented in accordance with a method 665 represented in the flowchart of FIG. 13. For each known object, an original image of the known object is captured and features are extracted from the original image (step 670). Multiple sample images of the known object from various viewpoints (with varied scale, in-plane and out-of-plane orientation and illumination) are be acquired, or different viewpoints of the known object are synthetically generated by applying various geometric transformations to the original image of the known object to acquire the sample images (step 675).

For each sample image of the known object, features are extracted and refined recognition is performed between the sample image and the original image (step 680). A count of votes is built for each feature extracted from the original image, the count representing the number of sample images for which the feature was part of the recognition match (step 685).

Once all sample images of a known object have been matched and all matched feature votes tallied, the top features of the original image having the most votes are selected for use in the coarse database (step 687). For example, the top 2% features of the known object may be selected.

The systems and methods described above may be used in various different applications. One commercial application is a tunnel system for retail merchandise checkout. One example of a tunnel system is described in commonly owned U.S. Pat. No. 7,337,960, issued on Feb. 28, 2005, and entitled “System and Method for Merchandise Automatic Checkout,” the entire contents of which are incorporated herein by reference. In such a system, a motorized belt transports object (e.g., items) to be purchased into and out of an enclosure (the tunnel). Within the tunnel lie various sensors with which a recognition of the objects is attempted so that the customer can be charged appropriately.

The sensors used may include:
Barcode readers aimed at various sides of the objects (laser-based, or image-based);
RFID sensors;
Weight sensors;
Multiple cameras to capture images of all sides of the objects (2-D imagers, and 1-D ‘pushbroom’ imagers or linescan imagers which utilize the motion of the belt to scan an object); and
Range sensors capable of generating a depth map aligned with one or more cameras/imagers.

Although barcode readers are highly reliable, due to improper placement of objects on the belt, or self occlusions, or occlusions by other objects, a considerable number of objects may not be identified by a barcode reader. For these cases, it may be necessary to attempt to recognize the object based on its visual appearance.

Because a typical retail establishment may have thousands of items for sale, a large database for visual recognition may be necessary, and the above described systems and methods of recognizing an object using a large database may be necessary to ensure a high degree of recognition accuracy and a satisfactorily low failure rate. For example, one implementation may have 50,000 items to recognize, which can be organized into, for example, approximately 200 small databases of 250 items each.

Due to the relatively controlled environment of the tunnel, various methods of reliably segmenting individual objects in the acquired images (using 3-D structure reconstruction from multiple imagers, and/or range sensors and depth maps) are conceivable and practical.

Another application involves the use of a mobile platform (e.g., a cell phone, a smart phone) with a built-in image capturing device (e.g., camera). The number of objects that a mobile platform user may take a picture of to attempt to recognize may be in the millions, so some of the problems introduced by storing millions of object models in a large database may be encountered.

If the mobile platform has a single camera, the segmentation of an object as described above may be achieved by:
Detecting the most salient object in the scene;
Using anisotropic diffusion and/or edge detection to determine the boundaries of the object in the center of the image;
Acquiring multiple images (or a short video sequence) of the object, and using optical flow and/or structure and motion estimation to segment the foreground object in the center of the image from the background;
Interactively guiding the user to prompt motion of the camera to enable object segmentation;
Applying a skin color filter to segment an object being held from the hand holding it; and
Implementing a graphical user interface (GUI) that enables the user to segment the object manually, or provide an indicator suggestion as to the location of the object of interest to aid some of the methods listed above.

Some mobile platforms may have more than one imager, in which multiple view stereo depth estimation may be used to segment the central foreground object from the background. Some mobile platforms may have range sensors that produce a depth map aligned with acquired images. In that case, the depth map may be used to segment the central foreground object from the background.

It will be obvious to skilled persons that many changes may be made to the details of the above-described embodiments without departing from the underlying principles of the invention. The scope of the present invention should, therefore, be determined only by the following claims.

1. A method of organizing a set of recognition models of known objects stored in a database of an object recognition system, the method comprising:
determining for each of the known objects a classification model;
grouping the classification models of the known objects into multiple classification model groups, each of the classification model groups identifying a corresponding portion of the database that contains the recognition models of the known objects having classification models that are members of the classification model group; and
computing representative classification models for the classification model groups, wherein a representative classification model of a classification model group is derived from the classification models that are members of the classification model group, and wherein the representative classification models are compared to a classification model of a target object when recognizing the target object to enable selection of a subset of the recognition models of the known objects for comparison to a recognition model of the target object.

2. The method of claim 1, wherein determining the classification model of a known object comprises measuring an appearance characteristic from an image of the known object.

3. The method of claim 2, wherein the appearance characteristic corresponds to one or more of color, texture, spatial frequency, shape, illumination invariant image properties and illumination invariant image gradient properties.

4. The method of claim 2, wherein the classification model of the known object is determined by:
segmenting an image of a scene captured by an image capturing device to produce an isolated image of the known object;
computing local feature descriptor vectors from the image of the known object, wherein the local feature descriptor vectors are within a feature descriptor vector space;
dividing the feature descriptor vector space into multiple regions;
determining which regions the local feature descriptor vectors belong to; and
creating a histogram that quantifies how many local feature descriptor vectors belong to each of the regions, the histogram corresponding to the classification model.

5. The method of claim 4, further comprising:
assigning to each of the regions a representative descriptor vector; and
comparing the local feature descriptor vectors to the representative descriptor vectors to determine which region the local feature descriptor vectors belong to.

6. The method of claim 2, wherein the classification model of the known object is determined by:
segmenting an image of a scene captured by an image capturing device to produce an isolated image of the known object;
applying a geometric transformation to the segmented image of the known object to obtain a normalized image of the known object; and
generating a single feature descriptor for the normalized image of the known object, the classification model including a representation of the single feature descriptor.

7. The method of claim 6, wherein the single feature descriptor is generated using the entire extent of the normalized image of the known object.

8. The method of claim 2, wherein the classification model of the known object is determined by:
segmenting an image of a scene captured by an image capturing device to produce an isolated image of the known object;
applying a geometric transformation to the segmented image of the known object to obtain a normalized image of the known object;
dividing the normalized image of the known object into multiple predetermined grid portions; and
generating for each grid portion of the divided image a feature descriptor vector, the classification model including a representation of the feature descriptor vectors of the grid portions.

9. The method of claim 2, wherein the classification model of the known object is determined by:
segmenting an image of a scene captured by an image capturing device to produce an isolated image of the known object;
applying a geometric transformation to the segmented image of the known object to obtain a normalized image of the known object, wherein a vector represents the normalized image; and
computing a principal component analysis representation of the vector representing the normalized image, the classification model including a representation of the principal component analysis representation of the vector.

10. The method of claim 1, wherein determining the classification model of a known object comprises measuring a physical property of the known object.

11. The method of claim 10, wherein the physical property is one or more of height, width, length, shape, mass, a geometric moment, volume, curvature, an electromagnetic characteristic and temperature.

12. The method of claim 10, further comprising measuring an appearance characteristic from an image of the known object, wherein the classification model of the known object includes a representation of the physical property of the known object and a representation of the appearance characteristic of the known object.

13. The method of claim 1, wherein the classification model groups are formed by using a clustering algorithm on the classification models.

14. The method of claim 13, wherein the classification models of the known objects are clustered using a k-means clustering algorithm.

15. The method of claim 13, wherein a number of the classification model groups into which the classification models are clustered is determined prior to the clustering.

16. The method of claim 13, wherein a number of the classification model groups in which the classification models are clustered is determined during clustering.

17. The method of claim 1, wherein the clustering includes soft clustering in which a classification model of a known object is clustered into one or more of the classification model groups and the recognition model of the known object is included in one or more of the portions of the database.

18. The method of claim 1, wherein a representative classification model of a classification model group corresponds to a mean of the classification models that are members of the classification model group.

19. The method of claim 1, wherein the classification model includes a classification signature that represents a n-dimensional vector.

20. A method of recognizing a target object from a database containing recognition models of a set of known objects, the database being divided into multiple portions, and each portion containing recognition models of a subset of the known objects, comprising:
receiving image data representing an image of the target object;
determining for the target object a classification model;
generating for the target object a recognition model derived from the image of the target object;
comparing the classification model of the target object to representative classification models associated with the portions of the database, the representative classification model of a portion of the database derived from classification models of a subset of the known objects having recognition models contained in the portion;
selecting a portion of the database to search based on the comparing; and
searching the selected portion of the database to identify a recognition model of a known object that matches the recognition model of the target object.

21. The method of claim 20, wherein determining the classification model of the target object comprises measuring an appearance characteristic from the image of the target object.

22. The method of claim 21, wherein the appearance characteristic corresponds to one or more of color, texture, spatial frequency, shape, illumination invariant image properties and illumination invariant image gradient properties.

23. The method of claim 21, wherein the classification model of the target object is determined by:
segmenting an image of a scene captured by an image capturing device to produce an isolated image of the target object;
computing local feature descriptor vectors from the image of the target object, wherein the local feature descriptor vectors are within a feature descriptor vector space;
dividing the feature descriptor vector space into multiple regions;
determining which regions the local feature descriptor vectors belong to; and
creating a histogram that quantifies how many local feature descriptor vectors belong to each of the regions of the feature descriptor vector space, the histogram corresponding to the classification model of the target object.

24. The method of claim 23, further comprising:
assigning to each of the regions a representative descriptor vector; and
comparing the local feature descriptor vectors to the representative descriptor vectors to determine which region the local feature descriptor vectors belong to.

25. The method of claim 21, wherein the classification model of the target object is determined by:
segmenting an image of a scene captured by an image capturing device to produce an isolated image of the target object;
applying a geometric transformation to the segmented image of the target object to obtain a normalized image of the target object; and
generating a single feature descriptor for the normalized image of the target object, the classification model including a representation of the single feature descriptor.

26. The method of claim 21, wherein the classification model of the target object is determined by:
segmenting an image of a scene captured by an image capturing device to produce an isolated image of the target object;
applying a geometric transformation to the segmented image of the target object to obtain a normalized image of the target object;
dividing the normalized image of the target object into multiple predetermined grid portions; and
generating for each grid portion of the divided image a feature descriptor vector, the classification model including a representation of the feature descriptor vectors of the grid portions.

27. The method of claim 21, wherein the classification model of the target object is determined by:
segmenting an image of a scene captured by an image capturing device to produce an isolated image of the target object;
applying a geometric transformation to the segmented image of the target object to obtain a normalized image of the target object, wherein a vector represents the normalized image; and
computing a principal component analysis representation of the vector representing the normalized image, the classification model including a representation of the principal component analysis representation of the vector.

28. The method of claim 20, wherein determining the classification model of the target object comprises measuring a physical property of the target object.

29. The method of claim 28, wherein the physical property is one or more of height, width, length, shape, mass, a geometric moment, volume, curvature, an electromagnetic characteristic and temperature.

30. The method of claim 28, further comprising measuring an appearance characteristic from the image of the target object, wherein the classification model of the target object includes a representation of the physical property of the target object and a representation of the appearance characteristic of the target object.

31. The method of claim 20, wherein the classification model of the target object and the representative classification models of the portions of the database are vectors and the comparing includes determining Euclidean distances between the classification model of the target object and the representative classification models, wherein the shortest Euclidean distance identifies the portion of the database to select for the searching.

32. The method of claim 20, wherein the recognition model of the target object and the recognition models of the known objects include feature descriptors.

33. The method of claim 32, wherein the feature descriptors are scale invariant feature transformation feature descriptors.

34. The method of claim 20, wherein multiple ones of the portions of the database are selected based on comparing the classification model of the target object to the representative classification models of the portions.

35. An object recognition system for recognizing a target object, comprising:
a database containing recognition models of a set of known objects, the database divided into multiple portions each containing recognition models of a subset of the known objects, wherein the portions have representative classification models, and wherein the representative classification model of a portion is derived from classification models of a subset of the known objects having recognition models contained in the portion; and
a processor comprising:
a classification module configured to generate for the target object a classification model, the classification module configured to compare the classification model of the target object to the representative classification models of the portions of the database to select a portion, and
a recognition module configured to receive image data representing an image of the target object and produce from the image data a recognition model of the target object, the recognition module configured to search a portion of the database selected by the classification module to identify a recognition model contained in the portion that matches the recognition model of the target object.

36. The system of claim 35, wherein the classification module is configured to receive the image data representing the image of the target object and generate the classification model of the target object from an appearance characteristic represented in the image data.

37. The system of claim 36, wherein the appearance characteristic is one or more of color, texture, spatial frequency, shape, illumination invariant image properties, illumination invariant image gradient properties, a histogram derived from quantized local feature descriptor vectors, a single feature descriptor representation derived from a normalized image of the target object, feature descriptor vectors corresponding to predetermined grid portions of a normalized image of the target object and a principal component analysis representation.

38. The system of claim 35, wherein the classification model of the target object includes a representation of a physical property of the target object.

39. The system of claim 38, wherein the physical property is one or more of height, width, length, shape, mass, a geometric moment, volume, curvature, an electromagnetic characteristic and temperature.

40. The system of claim 35, wherein:
the classification model of the target object and the representative classification models of the portions of the database are vectors;
the classification module is configured to determine Euclidean distances between the classification model of the target object and the representative classification models; and
the shortest Euclidean distance identifies the portion of the database to select.

41. The system of claim 35, wherein the recognition model of the target object and the recognition models of the known objects include feature descriptors.

42. The system of claim 41, wherein the feature descriptors are scale invariant feature transformation feature descriptors.

43. The system of claim 35, further comprising an image capturing device to produce the image data representing the image of the target object.
